(19) United States
(12) Patent Application Publication
(10) Pub. No.: US 2002/0147694 A1
(43) Pub. Date: Oct. 10, 2002

(54) Retraining trainable data classifiers

(76) Inventors: Derek M. Dempsey, London (GB); Kate Butchart, Herts (GB); Phil W. Hobson, Hertfordshire (GB)

Correspondence Address: William M. Lee, Jr., Lee, Mann, Smith, McWilliams, Sweeney & Ohlson, P.O. Box 2786, Chicago, IL, 60690-2786, US

(21) Appl. No.: 09/773,116

(22) Filed: Jan. 31, 2001

(51) Int. Cl. G06G 7/00; G06E 3/00; G06E 1/00; G06F 15/18

(52) U.S. Cl. 706/12; 706/20

(57) ABSTRACT

A method and apparatus is provided for retraining a trainable data classifier (for example, a neural network). Data provided for retraining the classifier is compared with training data previously used to train the classifier, and a measure of the degree of conflict between the new and old training data is calculated. This measure is compared with a predetermined threshold to determine whether the new data should be used in retraining the data classifier. New training data which is found to conflict with earlier data may be further reviewed manually for inclusion.

### FIELD OF THE INVENTION

The present invention relates to a method and apparatus for retraining trainable data classifiers (for example neural networks) and a system incorporating the same. One specific field of application is that of account fraud detection including, in particular, telecommunications account fraud detection.

### BACKGROUND TO THE INVENTION

Anomalies are any irregular or unexpected patterns within a data set. The detection of anomalies is required in many situations in which large amounts of time-variant data are available. For example, detection of telecommunications fraud, detection of credit card fraud, encryption key management systems and early problem identification.

One problem is that known anomaly detectors and methods of anomaly detection are designed for use with only one such situation. They cannot easily be used in other situations. Each anomaly detection situation involves a specific type of data and specific sources and formats for that data. An anomaly detector designed for one situation works specifically for a certain type, source and format of data and it is difficult to adapt the anomaly detector for use in another situation. Known methods of adapting an anomaly detector for use in a new situation have involved carrying out this adaptation manually. This is a lengthy and expensive task requiring specialist knowledge not only of the technology involved in the anomaly detector but also of the application domains involved.

One application for anomaly detection is the detection of telecommunications fraud. Telecommunications fraud is a multi-billion dollar problem around the world. Anticipated losses are in excess of $1 billion a year in the mobile market alone. For example, the Cellular Telecoms Industry Association estimated that in 1996 the cost to US carriers of mobile phone fraud alone was $1.6 million per day, projected to rise to $2.5 million per day by 1997. This makes telephone fraud an expensive operating cost for every telephone service provider in the world. Because the telecommunications market is still expanding rapidly the problem of telephone fraud is set to become larger.

Most telephone operators have some defence against fraud already in place. These risk limitation tools may make use of simple aggregation of call-attempts or credit checking, or may be tools to identify cloning, or tumbling. Cloning occurs where the fraudster gains access to the network by emulating or copying the identification code of a genuine telephone. This results in a multiple occurrence of the telephone unit. Tumbling occurs where the fraudster emulates or copies the identification codes of several different genuine telephone units.

Methods have been developed to detect each of these particular types of fraud. However, new types of fraud are continually evolving and it is difficult for service providers to keep “one-step ahead” of the fraudsters. Also, the known methods of detecting fraud are often based on simple strategies which can easily be defeated by clever thieves who realise what fraud-detection techniques are being used against them.

Another method of detecting telecommunications fraud involves using neural network technology. One problem with the use of neural networks to detect anomalies in a data set lies in pre-processing the information to input to the neural network. The input information needs to be represented in a way which captures the essential features of the information and emphasises these in a manner suitable for use by the neural network itself. The neural network needs to detect fraud efficiently without wasting time maintaining and processing redundant information or simply detecting “noise” in the data. At the same time the neural network needs enough information to be able to detect many different types of fraud including types of fraud which may evolve in the future. As well as this the neural network should be provided with information in a way that it is able to allow for legitimate changes in behaviour and not identify these as potential frauds.

It is known from U.S. Pat. No. 6,067,535 “Monitoring and Retraining Neural Networks” to provide a system for retraining neural networks by retraining a neural network in parallel with a “live” neural network, thereby reducing the time during which the neural network is unavailable for live use.

Whilst this reduces the overall system “downtime”, the time required to retrain the network in parallel may yet be significant, and requires valuable processing resources which could be used for other tasks.

A specific problem in training and retraining is that the training data employed may not be self-consistent and, when used for training, may give rise to sub-optimal, if not erroneous, results in later classifications when the system is running live”.

### OBJECT OF THE INVENTION

The invention seeks to provide an improved method and apparatus for retraining trainable data classifiers especially when applied in the context of account fraud detection, including, in particular, telecommunications account fraud detection.

### SUMMARY OF THE INVENTION

According to a first aspect of the present invention there is provided a method of retraining a trainable data classifier comprising the steps of: providing a first item of training data: comparing the first item of training data with a second item of training data already used to train the data classifier; calculating a measure of conflict between the first and second items of training data; using the first item of training data to retrain the data classifier responsive to the measure of conflict.

Preferably, the step of using the first item of training data is responsive to a predetermined conflict threshold value.

Preferably, the threshold value is non-zero.

Advantageously, the measure of conflict may comprise a geometric difference between the first and second items of training data.

Preferably, the geometric difference comprises a Euclidean distance.

Advantageously, the measure of conflict may comprise an association coefficient between the first and second items of training data.

Preferably, the association coefficient is a Jaccard's coefficient.

Preferably, the measure of conflict is derived from both a Euclidean distance and a Jaccard's coefficient between the first and second items of training data.

Preferably, the measure of conflict is derived from a Euclidean distance and a Jaccard's coefficient composed in an exponential relationship with respect to each other.

Preferably, the measure of conflict is derived from a function of a Euclidean distance multiplied by an exponent of a function of the Jaccard's coefficient.

Preferably, the data classifier comprises a neural network.

In one preferred embodiment the training data comprises telecommunications network data.

In a further preferred embodiment the training data comprises telecommunications call detail record data.

According to a further aspect of the present invention there is provided a method of training a trainable data classifier comprising the steps of: providing a plurality of items of training data; comparing a first of the items of training data with a second of the items of training data; calculating a measure of conflict between the first and second items of training data; using one of the first and second items of training data to retrain the data classifier responsive to the measure of conflict.

The invention also provides for a system for the purposes of data processing which comprises one or more instances of apparatus embodying the present invention, together with other additional apparatus.

According to a further aspect of the present invention there is provided apparatus for retraining a trainable data classifier, comprising: an input port for receiving a first item of training data; a comparator arranged to compare the first item of training data with a second item of training data already used to train the data classifier; a calculator for calculating a measure of conflict between the first and second items of training data; and an output port arranged to output the first item of training data to the data classifier responsive to the measure of conflict.

The present invention also provides for an anomaly detection system, a telecommunications data anomaly detection system, a telecommunications fraud detection system, or an account fraud detection system comprising the above mentioned apparatus.

The present invention also provides an apparatus for retraining a trainable data classifier comprising: an input port for receiving items of training data; a comparator arranged to compare a first of the items of training data with a second of the items of training data; a calculator for calculating a measure of conflict between the first and second items of training data; and an output port arranged to output the first item of training data to the data classifier responsive to the measure of conflict.

The invention is also directed to a program for a computer, comprising components arranged to perform the steps of any of the methods described above.

Specifically, the present invention provides a program for a computer on a machine readable medium arranged to perform the steps of: receiving a first item of training data; comparing the first item of training data with a second item of training data already used to train the data classifier; calculating a measure of conflict between the first and second items of training data; using the first item of training data to retrain the data classifier responsive to the measure of conflict.

There is also provided a program for a computer on a machine readable medium arranged to perform the steps of: receiving a plurality of items of training data; comparing a first of the items of training data with a second of the items of training data; calculating a measure of conflict between the first and second items of training data; and using one of the first and second items of training data to retrain the data classifier responsive to the measure of conflict.

The preferred features may be combined as appropriate, as would be apparent to a skilled person, and may be combined with any of the aspects of the invention.

### BRIEF DESCRIPTION OF THE DRAWINGS

In order to show how the invention may be carried into effect, embodiments of the invention will now be described, by way of example only, and with reference to the accompanying figures in which:

FIG. 1 illustrates how new training data may be assessed and used in accordance with the invention;

FIG. 2 shows an example of conflict identification according to the present invention; and

FIG. 3 shows a flow chart of a method in accordance with the present invention;

### DETAILED DESCRIPTION OF INVENTION

A trainable data classifier cannot retrain effectively on new training data that conflicts with the existing training data stored in the knowledge base previously used to train the data classifier. In practice a neural network data classifier generally takes a decision to ignore conflicts if they are numerically insignificant compared to the knowledge base size: for example 4 conflicts out of 1400 examples. The existence of the conflicts in a training set is detrimental for a number of reasons:

The neural network may not reach the required performance because of the effect of the conflicts, for example on the rms-error frequently used to measure neural network performance.

The training process is made more difficult, and may lead the neural network to be over-trained thus rendering further additions of data difficult. The neural network becomes impervious.

The conflicts, if not addressed, will affect subsequent retraining cycles. Even if the network achieves its target performance on a given retraining cycle, the continued presence of the conflicts makes future retraining to the target performance difficult.

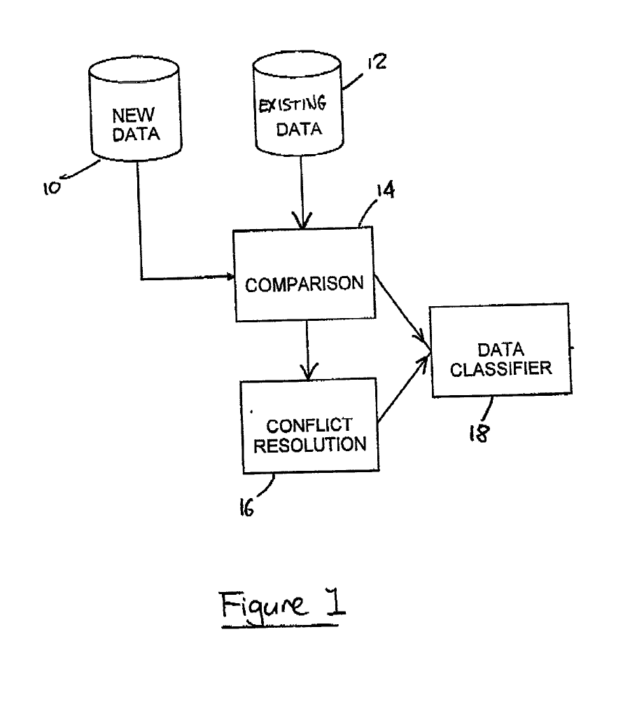

FIG. 1 is illustrative of processes involved in adding new training data 10 to old or existing training data 12. By performing a comparison 14 of the new and existing data, any conflicts between the two can be resolved by a conflict resolution step 16, and the appropriate combination of data used to retrain the data classifier 18.

Similarity Assessment

Typically, an item of training data contains an input element, such as a vector containing a plurality of independent parameters, and an output element, which may be a single output value. In a strict sense, one item of training data conflicts with another if the two input elements are identical but the output elements or values are different. However, a broader interpretation allows two items which have very similar input elements but also contain conflicting output values to be considered to be conflicting.

The similarity of two vectors or input elements can be measured in a number of ways. A common and robust method is to calculate the Euclidean distance between them. This is found by squaring the difference between corresponding elements in the two vectors and summing across all elements.

The Euclidean distance does not perform particularly well as a measure of vector similarity under some circumstances, and in particular can lead to misleading results when trying to assess conflicts between items of training data for a data classifier.

Some alternative measures of vector similarity or difference are discussed in copending U.S. patent application Ser. No. ______, entitled “Vector Difference Measures for Data Classifiers”, filed on the same day as the present application, the content or which is incorporated herein by reference.

One alternative type of difference or similarity measure not previously used in the field of trainable data classifiers is that of association coefficients. In general, an association coefficient is a numerical summation of measures of correlation of corresponding elements of two data vectors. Typically, this is achieved by a quantisation of the elements of the two vectors into two levels by means of a threshold, followed by a counting of the number of elements quantised into a particular one of the levels in both of the vectors. Positive and negative thresholds may be used for vectors having elements which initially have values which may be either positive or negative.

Usually, all elements having values above a given threshold are considered to be present, or significant, and all elements having values below the threshold are considered to be absent or insignificant. Clearly there is an degree of arbitrariness about the threshold value used which will vary from application to application.

The use of association coefficients may be considered by reference to a simple association table, as follows:

TABLE 1

data vector 1

| | | 1 | 0 |
|---|---|---|---|
| data | 1 | a | b |
| vector | 0 | c | d |
| 2 | | | |

In table 1, a “1” indicates the significance of a vector element, and “0” indicates its insignificance. The counts a, b, c and d correspond to the number of vector elements in which the two vectors have the quantized values indicated. For example, if there were 10 elements where both vectors were zero, insignificant, or below the defined threshold, then d would be 10.

Association coefficients generally provide a good measure of similarity of shape of two data vectors, but no measure of quantitative similarity of the values of given elements.

A particular association coefficient that can be used to determine data vector similarity or difference is the Jaccard's coefficient. This is defined as:

$$S = \frac{a}{a + b + c}$$

Where a, b and c refer to the associations given in table 1 above.

The Jaccard's coefficient has a value between 0 and 1, where 1 indicates identity of the quantized vectors and 0 indicates maximum dissimilarity A more generalised association coefficient scheme needs to accommodate negative values that may appear in the data vectors. Conveniently, negative values may follow the same logic as positive values, a value being significant if it is below a negative threshold. It is not necessary for this threshold to have the same absolute value as the positive threshold but it may do so.

The following more complex association table may then be defined for calculating the Jaccard's coefficient using the formula given above:

TABLE 2

data vector 1

| | | 1 | −1 | 0 |
|---|---|---|---|---|
| data | 1 | a | b | b |
| vector | −1 | c | a | b |
| 2 | 0 | c | c | d |

An alternative to the Jaccard's coefficient is a paired absences coefficient, given by:

$$T = \frac{a + d}{a + b + c + d}$$

Where a, b, c and d refer to the entries in tables 1 and 2 above. However, in sets of relatively sparsely populated data vectors typical of telecommunications fraud detection data, there tend to be large numbers of paired absences, and the Jaccard's coefficient is usually preferable.

Another alternative association coefficient scheme using real or binary variables is known as Gower's coefficient. This requires that a value for the range of each real variable in the data vectors is known. For binary variables, Gower's coefficient represents a generalisation of the two methods outlined above.

Combinations of geometric and association coefficient measures, and in particular, but not exclusively, of Euclidean distance and Jaccard's coefficient measures provide improved measures of data vector similarity or difference for use in telecommunications fraud applications. Two possible types of combination are as follows. The first is numerical combination of two or more measures to form a single measure of similarity or distance. The second is sequential application. A two stage decision process can be adopted, using one scheme to refine the results obtained by another. Since numerical values are generated by both geometric and association coefficient measures it is a more convenient and versatile approach to adopt an appropriate numerical combination rather than using a two stage process.

While geometric measures such as Euclidean distance generally decrease for increasing vector similarity, the converse is generally true for association coefficients. Consequently, if the geometric and association measures are to be given equal or similar priority then a simple ratio, using optional constants, can be used. This will tend to lead to some problems with division by small numbers, but these problems may be surmounted. If one or other of the geometric and association measures is to be accorded preference then the combination can be achieved by taking a logarithm or exponent of the less important measures Two further methods of combination are to multiply the geometric or Euclidean distance E by an exponent of the negated association or Jaccard's coefficient S (“modified Euclidean”), and to multiply the association or Jaccard's coefficient S by an exponent of the negated geometrical Euclidean distance E (“modified Jaccard”), with the inclusion of suitable constants k₁ and k₂ as follows:

Modified Euclidean: D=E exp(−k₁S)

Modified Jaccard: R=S exp(−k₂E)

Other suitable constants may, of course, be introduced to provide suitable numerical trimming and scaling, and of course functions other than exponentials, such as other power functions could equally be used.

Conflict Assessment

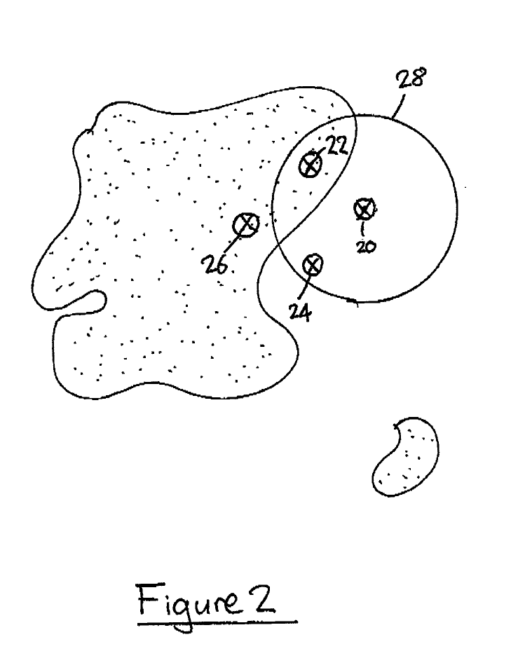

Referring to FIG. 2, the plane of the figure is representative of the vector space of input elements of data items for use with a data classifier. The shaded and unshaded areas are representative of different values of corresponding output elements which could indicate, for example, fraudulent and non-fraudulent activity. Even a simple binary output may be distributed across the input vector space in a complex manner, the data classifier being trained or constructed to provide a mapping from the input space to the output space which both conforms closely to the training data and provides a reasonable mapping in respect of new input data spaced between elements of training data.

A method proposed for assessing conflict between a proposed new training data item 20 and an existing knowledge base is to find the nearest neighbour 22, in terms of the input space, of a number of nearest neighbours 22, 24, 26 already in the knowledge base The new item 20 then conflicts with a nearest neighbour if the input elements are sufficiently similar, for example with reference to a threshold 28, and they have conflicting output elements. Similarity may conveniently be determined on the basis of a simple geometric distance. In FIG. 2, data item 22 conflicts with item 20 under this scheme, whereas items 24 and 26 do not. If necessary, a threshold or similar device applied to a suitable measure of difference may be used to assess the conflict between two output elements.

Some alternative measures, such as the measures based on association coefficients described above may be used to define a similarity value other than a purely geometric distance measure, in which case a conflict would exist when the similarity was above some defined threshold value.

It is sometimes desirable to find a set of nearest neighbours rather than a single nearest neighbour but, providing conflict management is maintained, the single neighbour approach is typically adequate. It should also be possible to refine the search to improve efficiency but this is not a major concern for such an occasional activity.

The threshold distance 28 may need to be determined empirically. If the data validated represents a new fraud type for instance, then it may represent a vector positioned between fraud and expected vector clusters on the decision surface but marginally closer to the expected. This would be acceptable providing the distance between expected and new is sufficient.

Conflict Resolution

Once a conflict has been identified a number of options exist as to how it is handled.

One simple solution is not to add any conflicts to the knowledge base but this is not necessarily satisfactory. It would be undesirable for users of a data classifier system to find that they are providing useful training data which is then being ignored by the system.

A second alternative is to accept all new training data and remove conflicting training data from the existing knowledge base. This is not always satisfactory for several reasons, in particular;

the knowledge base can be easily degraded, intentionally or unintentionally following this approach, and

this approach may require the removal of several examples to eliminate the conflict.

Since neither of these solutions is universally satisfactory, conflict resolution of training data cannot realistically be a wholly automated activity. The user is required to arbitrate in some way.

Conflict Types

A data classifier system detecting anomalies such as telecommunications account fraud may generate positive alarms indicating fraud and negative results indicating no fraud, which are subsequently validated by a user of the system to be either true or false. Such validations can be grouped into the following four types:

1) TRUE POSITIVES are: fraud alarms which are validated as correct. These will not conflict with the existing knowledge base already used to train the data classifier and adding them to the knowledge base should reinforce correct data classifier behaviour.

2) FALSE POSITIVES may be the main cause of difficulty. If they are added to the knowledge base they may well cause conflict with existing training data. The main choice here is as to whether a false positive alarm is to be considered spurious rather than simply false. If spurious, then this implies some change in the neural network behaviour is required (or at least desirable).

3) TRUE NEGATIVES are unlikely to be added to the existing training data, although unusual examples may sometimes be used. These should not lead to conflicts since established behaviour is being confirmed.

4) FALSE NEGATIVES fall into two categories:

unusual alarms that are validated as fraud;

accounts which are discovered to be fraud but missed by the neural network.

In addition, it is worth including the possibility of customer-developed scenarios. These too may conflict with the training data in the current knowledge base. In this case it would seem preferable to remove the conflicting data from the current knowledge base to allow users of the data classifier system to specify their own scenarios. However, if this requires the removal of several examples from the knowledge base then it should be considered carefully.

Preferred Resolutions of conflicts are:

1. 1. TRUE POSITIVES should take precedence over conflicting data in the existing knowledge base. The conflicting data should be removed from the knowledge base to accommodate the new data. However, they should not be totally discarded, partly in case there is a need to retreat, partly to maintain a set of potentially useful examples. It is considered that conflicts in this category will be very rare.

2. FALSE NEGATIVES should be added to the knowledge base. Any conflicts should be removed from the existing knowledge base and retained for future reference.

3. TRUE NEGATIVES can be added to the knowledge base to reinforce behaviour and to maintain currency. This is probably optional but these can be used to maintain balance in the knowledge base.

4. FALSE POSITIVES will generally represent the most common type of data which the user of a data classifier system may wish to add to training data of the current knowledge base. Sometimes these should be added to the knowledge base and conflicts pruned and sometimes they should not. This decision will need to be taken by an experienced user.

5. USER-DEFINED SCENARIOS would generally be expected to override data in the current knowledge base if this does not require excessive pruning. In effect these would be treated as TRUE POSITIVES.

Conflict Management

In most cases it is anticipated that added knowledge will be compatible with the existing training data knowledge bases in particular in the case of validated alarms and new fraud scenarios. The main source of conflict will almost certainly come from the category of false positives. Any system will inevitably generate false positives and these cannot be entirely eliminated. It should be made clear to users of a trainable data classifier that false positives should only be validated as incorrect if the behaviour would never be indicative of fraud. The invention however allows the system to intercept inconsistent validations of this type alerting the user to the conflict.

Knowledge Pruning

There is no evident difficulty when examples are removed from a set of potential new training data. There is a difficulty however when examples have to be removed from the existing training data knowledge base. This difficulty is exacerbated by the duplication that frequently occurs in a start-up knowledge base delivered with a data classifier system to a user. Some of this duplication can be eliminated but some is almost certainly inevitable. In the training of a telecommunications fraud detection system a sufficiently wide range of examples of normal customer behaviour is required and these must be matched by fraud examples to provide a balanced training data knowledge base.

Assuming that duplication is minimised but still exists the problem associated with removal of conflicts from the knowledge base is:

that a single new item of training data may conflict with many existing examples;

that removal of all conflicting items Could lead to an unbalanced knowledge bases particularly if the conflicts are mainly aimed at removing certain types of false positive; and

that failure to remove conflicts would mean that the neural network is less likely to learn the new behaviour.

It is likely that some new items of training data will conflict with some of the examples in the existing knowledge base. Providing the user is certain that they want to add a new item and remove the resulting conflicts then the remaining question concerns the depth of conflict in the knowledge base, typically a measure of how many examples in the knowledge base conflict. It is possible that there may be several conflicting examples.

It is not a problem if there are only 2 or 3 conflicting examples in a large data set. These can be removed from the knowledge base and stored as discards. However there may be larger numbers of conflicts because of duplication in the existing knowledge base. If some of the duplication is reduced then this figure may reduce to a more manageable level. Ideally it should be possible to get the figure down to a small number, perhaps 5 at most, for any particular conflict. If this can be done by reducing the duplication in the knowledge base then this would represent a safe number to remove from the knowledge base. Ideally, all conflicts should be removed when the user requests a validated conflicting new item of training data to be added.

Redundancy Checking

Redundancy checking may involve checking all of the existing knowledge base of training data for duplication, and pruning examples which are very similar. An alternative redundancy check could be performed where no more than a predetermined number, for example 5, neighbours were permitted within a predefined conflict distance. This could be done as an alternative check or as a complementary check. A potential drawback with this approach is that the expected examples where behaviour is often quite minimal will be pruned excessively. The alternative redundancy check could be applied, however, solely to the fraud examples. The main cause of concern is pruning fraud cases from the knowledge of not expected behaviour cases. It is very unlikely that examples classified as normal behaviour where little activity is observed, however, will be re-classified as fraud.

Discard File

Data removed from the knowledge base may be stored and maintained by the system for possible future restoration. The data removed will be in the form of fraud ‘scenarios’ and hence a register of removed/replaced scenarios can be maintained

User-Defined Scenarios

If users of a telecommunications account fraud detection system define a fraud scenario which conflicts with the data in the existing knowledge base, there must be an assumption of precedence for the user-defined data. This is unproblematic since only non-fraud examples would be stripped from the database and these could be readily replaced by non-conflicting examples.

In the unlikely event that such users define scenarios which are of expected behaviours which look like fraud in order to eliminate particular scenarios that the system identifies as fraud but never are, then any resulting conflicts can be treated in the same way as examples of false positives.

Summary of Conflict Types

A detailed analysis of all the possible conflict circumstances indicates that the only likely area of difficulty for any conflict resolution concerns the false positive alarms generated by the neural network or defined by the users. There seems little scope for any automated decision procedure here since it becomes a matter of judgement whether to attempt to eliminate these alarms, and potentially lose true positives, or not and potentially have too many false alarms. There needs to be a judgement, based on the individual case, whether such behaviour is ever likely to be fraudulent. If it is not then the data classifier should be retrained to reclassify these behaviours. This would involve pruning some scenarios from the knowledge base of existing training data.

If it is judged that these scenarios, though false positives, could sometimes be indicative of fraud then they should remain in the knowledge base. This decision must be made by a knowledgeable system user.

The streamlining of the knowledge bases provided to customers should go some way towards reducing the number of conflicts that can occur in any situation. The extended redundancy checking could then be used to minimise the possibility that the number of fraud conflicts is more than 5 in any particular case. (This method probably would not apply to the expected behaviour examples however). The user could then be notified of all conflicts (perhaps up to a pre-determined maximum of 8 say) which need to be removed in order to consistently add the new example. In practice the maximum may be lower. It should then be safe to adopt a policy of removing all conflicts.

A combination of knowledge base management and conflict management should allow for all conflicts to be removed upon request by the user.

Pruning the Knowledge Base to Accommodate Acceptable Conflicts

The ability of a data classifier to detect fraud and of the knowledge base of training data to provide for continuous learning through gradual accumulation and periodic retraining depends upon tight control of this process.

It is possible to modify a neural network's behaviour by presenting new examples of fraud. It is also possible to modify a neural network by presenting new examples of expected behaviour. Some of these examples may be drawn from the actual alarms raised by the system. Indeed it is likely that most of these will do so and that the users will use the validation process to reduce the incidence of false positives. As discussed elsewhere, there are two types of false positives, those that indicate suspicious behaviour but the account is not in fact fraudulent, and those that are spurious and are considered never to be indicative of fraud. It is the latter cases that should be validated as expected behaviour. If the first type are validated then the neural network will eventually fail to alert the user to this type of behaviour and fraud will be missed.

In some cases, a new item of training data will conflict with the existing training data. When this occurs, the new item and the conflicts may be referred to the user or the administrator user for confirmation. If the validation is confirmed then, where possible the conflicting cases in the knowledge base may be removed. The difficulty here is that the conflict may be with several examples and thus removal is problematic. Initially an assumption may be made that no more than 3 cases should be removed from the knowledge base so that an entry that requires removal of more than this cannot be added. This protects the knowledge base from wholesale damage but will not be very popular with some users.

The method currently used to construct the knowledge base does use duplication and therefore it is highly likely that this type of multiple conflict will occur.

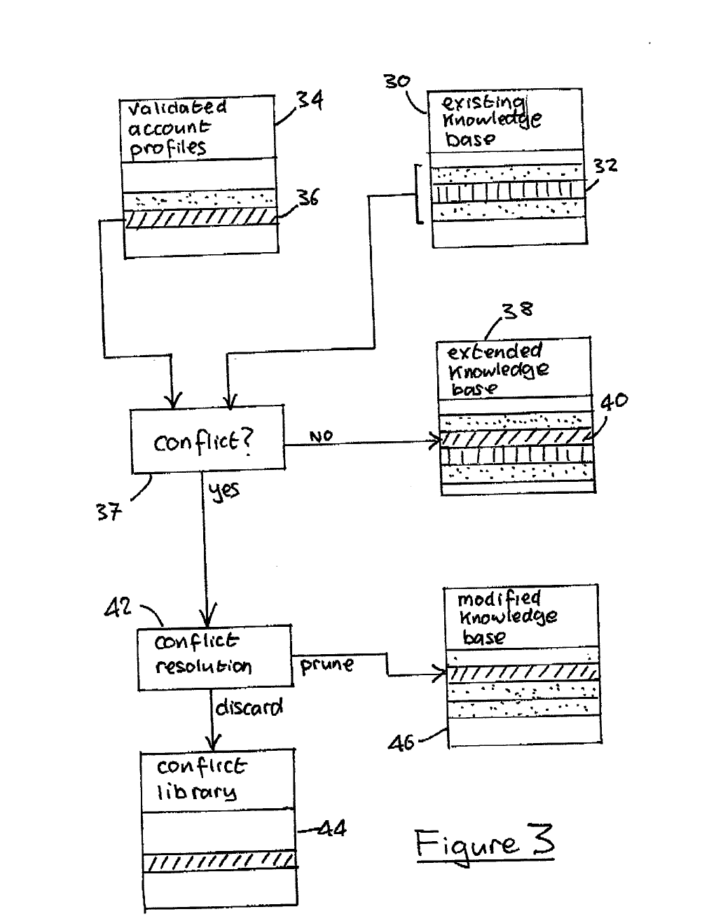

Referring now to FIG. 3, there is shown a flow diagram setting out certain aspects of the data classifier training data conflict resolution methods discussed above. An existing knowledge base 30 comprises a plurality of training data items 32, each item comprising an input element and an output element. For the telecommunications account fraud context discussed, the output element may simply indicate confirmed fraud, or confirmed absence of fraud in respect of a particular input element.

A source of new training data 34 is also shown. This source comprises validated account profiles 36. The validated account profiles 36 comprise input data elements, based on real examples of account data such as telecommunications account data and corresponding output elements indicative of confirmed fraud or confirmed no fraud.

The validated account profiles 36 are checked for conflict with the training data items 32 contained within the existing knowledge base at step 37 as described above. If no conflict is found then a validated account profile may be added to the existing knowledge base 30 to form an extended knowledge base 38 containing the validated account profile as new training data 40. If conflict is sound then a conflict resolution step 42 must be used. Two options at the conflict resolution step are shown. The first is to discard the conflicting validated account profile, preferably placing it in a conflict library 44 for future reference rather than discarding it altogether. The second is to add the conflicting validated account profile to the existing knowledge base 30 and to remove the conflicting existing item of training data 32, to form a modified knowledge base 46. Which option is chosen in the conflict resolution step will depend on the nature of the conflict and the data, as discussed above.

Other sources of new training data may include customer supplied scenarios, comprising fictitious input and output data elements provided by the user in order to influence the behaviour of the data classifier as desired. If customer supplied scenarios conflict with the elements of training data 32 in the existing knowledge base 30 then the conflicting existing elements 32 would typically be discarded from the knowledge base 30, but retained in a conflict library.

Experimentation

A small potential conflict set of 9 examples was prepared and tested for conflict against a known knowledge base of 1472 examples relating to telecommunications account fraud. It was found that 6 of the examples were identified as conflicts. Of these 6 examples, 5 conflicted with 20 cases in the knowledge base and 1 with 16 cases. The administrator might want to add this.

Case 1: A low PRS profile (1440 secs) of new behaviour with little other usage was reclassified as expected behaviour. The conflict checker found 20 cases of low PRS fraud examples in the knowledge base.

Case 2: Also low PRS reclassified.

Case 3: A small amount of national usage was reclassified as fraud. Conflict found with 20 examples as expected. This would be a spurious validation.

Case 4: A small amount of local usage was reclassified as fraud. See case 3.

Case 5: Similar to case 3.

Case 6: Similar to case 3.

Some further cases were constructed:

Case 7: A constructed ‘fraud’. No conflict was generated.

Case 8: High international 1 usage reclassified as expected. When sufficiently high usage level was set conflicts occurred.

Case 9: High international 2 usage reclassified as expected. No conflicts were generated. There were no examples of this type of usage classified as fraud. Some much lower volume usage was classified as expected behaviour.

The four cases identified (1, 7, 8, 9) when analysed by the existing neural network were all completely mis-classified as expected.

Examples 7 and 9 are nevertheless cases that would be added to the knowledge base automatically. Some pruning would be required before cases 1 and 8 could be added.

In this experiment the four interesting cases are 1, 7, 8 and 9. Case 1 is a realistic scenario where some behaviour which has been classified as fraud is re-classified as expected. The customer wants higher levels of activity before receiving an alarm. In this case all the conflicts need to be removed from the knowledge base. This is an example where there is a great deal of duplication. This duplication needs to be reduced in order for the conflict strategy to work well. We need to ensure that there are sufficient examples of higher activity remaining in the knowledge base. A greater variety of examples would help here. This has now been introduced into the customer knowledge base creation and therefore the duplication will be reduced.

In case 7, the user defined fraud scenario there is no conflict which is as expected.

In cases 8 and 9 we have the same scenario as case 1. However, the number of conflicts generated is either none or a few and this is compatible with the strategy of removing all conflicts.

Any range or device value given herein may be extended or altered without losing the effect sought, as will be apparent to the skilled person for an understanding of the teachings herein.

1. A method of retraining a trainable data classifier comprising the steps of:
providing a first item of training data;
comparing the first item of training data with a second item of training data already used to train the data classifier;
calculating a measure of conflict between the first and second items of training data;
using the first item of training data to retrain the data classifier responsive to the measure of conflict.

2. A method according to claim 1 wherein the step of using the first item of training data is responsive to a predetermined conflict threshold value.

3. A method according to claim 2 wherein the threshold value is non-zero.

4. A method according to claim 1 wherein the measure of conflict comprises a geometric difference between the first and second items of training data.

5. A method according to claim 4 wherein the geometric difference comprises a Euclidean distance.

6. A method according to claim 1 wherein the measure of conflict comprises an association coefficient of the first and second items of training data.

7. A method according to claim 6 wherein the association coefficient is a Jaccard's coefficient.

8. A method according to claim 7 wherein the measure of conflict is derived from a both a Euclidean distance between and a Jaccard's coefficient of the first and second items of training data.

9. A method according to claim 8 wherein the measure of conflict is derived from a Euclidean distance and a Jaccard's coefficient composed in an exponential relationship with respect to each other.

10. A method according to claim 8 wherein the measure of conflict is derived from a function of a Euclidean distance multiplied by an exponent of a function of the Jaccard's coefficient.

11. A method according to claim 1 wherein the data classifier comprises a neural network.

12. A method according to claim 1 wherein the training data comprises telecommunications network data.

13. A method according to claim 1 wherein the training data comprises telecommunications call detail record data.

14. A method of training a trainable data classifier comprising the steps of:
providing a plurality of items of training data;
comparing a first of the items of training data with a second or the items of training data;
calculating a measure of conflict between the first and second items of training data;
using one of the first and second items of training data to retrain the data classifier responsive to the measure of conflict.

15. A apparatus for retraining a trainable data classifier and comprising:
an input port for receiving a first item of training data;
a comparator arranged to compare the first item of training data with a second item of training data already used to train the data classifier;
a calculator for calculating a measure of conflict between the first and second items of training data; and
an output port arranged to output the first item of training data to the data classifier responsive to the measure of conflict.

16. A anomaly detection system comprising apparatus according to claim 15.

17. A telecommunications data anomaly detection system comprising apparatus according to claim 15.

18. A telecommunications fraud detection system comprising apparatus according to claim 15.

19. An account fraud detection system comprising apparatus according to claim 15.

20. An apparatus for retraining a trainable data classifier comprising:
an input port for receiving a plurality of items of training data;
a comparator arranged to compare a first of the items of training data with a second of the items of training data;
a calculator for calculating a measure of conflict between the first and second items of training data;
an output port arranged to output the first item of training data to the data classifier responsive to the measure of conflict.

21. A program for a computer on a machine readable medium arranged to perform the steps of:
receiving a first item of training data;
comparing the first item of training data with a second item of training data already used to train the data classifier;
calculating a measure of conflict between the first and second items of training data;
using the first item of training data to retrain the data classifier responsive to the measure of conflict.

22. A program for a computer on a machine readable medium arranged to perform the steps of:
receiving a plurality of items of training data;
comparing a first of the items of training data with a second of the items of training data;
calculating a measure of conflict between the first and second items of training data; and
using one of the first and second items of training data to retrain the data classifier responsive to the measure of conflict.
